(19) United States
(12) Patent Application Publication
(10) Pub. No.: US 2005/0082996 A1
(43) Pub. Date: Apr. 21, 2005

(54) High precision constant velocity power off retract using switched capacitor technique

(76) Inventor: Juergen Luebbe, Plano, TX (US)

Correspondence Address: Dan Swayze;Texas Instruments Incorporated, M/S 3999, P. O. Box 655474, Dallas, TX, 75265, US

(21) Appl. No.: 10/688,826

(22) Filed: Oct. 17, 2003

(51) Int. Cl. H02P 5/00

(52) U.S. Cl. 318/268

(57) ABSTRACT

An apparatus for controlling an actuator having a moveable member and having a coil that influences movement of the member, by provision of a drive current to the coil in response to a target speed voltage signal. The apparatus includes a sensing unit (11) for sensing a voltage corresponding to the voltage across said coil and providing a first signal (BEMF) corresponding to the sensed voltage and indicative of the velocity of the moveable member. The apparatus further includes a generation circuit (13) for providing a second signal (TBEMF) indicative of a target voltage corresponding to a target velocity for the moveable member and a controller (12) receiving the first signal and the second signal and responsive thereto for determining a compensation signal characterized as an analog type response regulated to the target voltage for effectuating the target velocity.

### FIELD OF THE INVENTION

The present invention relates generally to control circuits and, more particularly, to a switch capacitor arrangement for velocity control of an actuator.

### BACKGROUND OF THE INVENTION

Conventional actuators, sometimes referred to as “motors”, have a movably supported member, and a coil. When a current is passed through the coil, a motive force is exerted on the member. A control circuit is coupled to the coil in order to controllably supply current to the coil. One example of such an arrangement is found in a hard disk drive, where the movable member of the actuator supports a read/write head adjacent a rotating magnetic disk for approximately radial movement of the head relative to the disk. There are situations in which it is desirable to move the member to one end of its path of travel at a predetermined velocity which is less than its maximum velocity. An example of such a situation is a power failure. In such a situation, it is desirable to move the member to a parking location.

When a current is applied to the coil of the actuator, the member is subjected to a force tending to accelerate the member at a rate defined by the magnitude of the current. Consequently, in order to accelerate or decelerate the member until it is moving at a desired velocity, it is important to know the actual velocity of the member. In this regard, it is known that the back-EMF voltage on the coil of the actuator is representative of the velocity of the member.

It is desired to have a control circuit for an actuator that accurately monitors the back-EMF of the actuator coil and effectively controls the movement of the actuator member under widely varying load conditions, so as to, for example, permit the control parking of a disk drive member throughout the path of its travel.

### SUMMARY

The present invention achieves technical advantages as an apparatus for controlling an actuator having a moveable member and having a coil that influences movement of the member via a drive current to said coil. The apparatus provides a current signal to an actuator having a moveable member and a coil that influences movement of the member responsive to the current signal, wherein the apparatus includes a first input for receiving a first signal corresponding to the voltage sensed across the coil which is indicative of the velocity of the moveable member and a second input for receiving a second signal indicative of a target voltage corresponding to a target velocity for the moveable member. A node receives the first signal and the second signal and determines a difference therebetween and provides the difference to a proportional part and an integrator part. The integrator part providing a third signal which is indicative of a mathematical integration of the difference and the proportion part providing a forth signal which is indicative of a multiple of the difference. Further having a summing node for receiving the third signal and the forth signal and responsive thereto for determining a compensation signal from a sum of the third and forth signal, the compensation signal characterized as an analog type response regulated to the target voltage for effectuating the target velocity.

### BRIEF DESCRIPTION OF THE DRAWINGS

For a more complete understanding of the present invention, reference is made to the following detailed description taken in conjunction with the accompanying drawings wherein:

FIG. 1 illustrates a constant velocity sampled retract system in accordance with exemplary embodiments of the present invention;

FIG. 2 shows a diagram of an SC integrator in accordance with exemplary embodiments of the present invention;

FIG. 3 shows an SC controller based on the SC integrator shown in FIG. 2 in accordance with exemplary embodiments of the present invention;

FIG. 4 shows an SC controller with error cancellation in accordance with exemplary embodiments of the present invention;

FIG. 5 illustrates a graphical representation of step responses for the UDC approach and the present SC approach;

FIG. 6 illustrates a graphical representation of voltage resolution for the UDC approach and the present SC approach; and

FIG. 7 illustrates phase timing in accordance with exemplary embodiments of the present invention.

### DETAILED DESCRIPTION

The numerous innovative teachings of the present application will be described with particular reference to the presently preferred exemplary embodiments. However, it should be understood that this class of embodiments provides only a few examples of the many advantageous uses and innovative teachings herein. In general, statements made in the specification of the present application do not necessarily delimit any of the various claimed inventions. Moreover, some statements may apply to some inventive features, but not to others. Throughout the drawings, it is noted that the same reference numerals or letters will be used to designate like or equivalent elements having the same function. Detailed descriptions of known functions and constructions unnecessarily obscuring the subject matter of the present invention have been omitted for clarity.

Modern hard disc drives more and more have ramp-loading as an implementation to provide a save position for the read-write head. For those drives a constant velocity control for the VCM is the appropriate solution to bring the head from the disk surface to the safe park position. For the speed regulation in such a system two controlling functions are needed to achieve an optimum performance: an integrator part to provide high DC gain and a proportional part for fast response on big errors. Such a system is described in Brito et al., U.S. Pat. No. 6,040,671, the description of which is hereby incorporated by reference.

In this type of system (hereinafter referred to as the UDC approach), the integrator part is designed as a digital counter driving a digital to analog converter in which if the error is negative, the counter is decreased by one bit and if the error is positive the counter is increased. However, this type of solution has a limited response. For example, the integrator reacts relatively slowly to large changes in velocity, because it changes by only one bit per sample period (applying a step error to the system would lead to a constant slope answer, rather than a more advantageous exponential one).

Further, there is a finite error on using a UDC approach, because the target can only be as accurate as the digital to analog resolution (e.g. a DAC resolution of 10 mV can lead to a 10 mV error on the system). As hard disc drives get smaller and smaller, the characteristic electrical motor parameters drop (e.g. the torque constant Kt of the VCM). A drop in Kt in particular means that for a given speed of the VCM one would read smaller voltages as a BEMF. For a given error budget this would obviously lead to affect system error in a negative way. In future drives, the hard disc manufacturers expect the VCM to be moved into a save position with a low target Back-EMF (which is proportional to the motor speed) in the range of 50 mV with at least 10% accuracy (approximately 5 mV). Conventional circuitries have a random system error in the range of +/−20 mV, which might even be higher considering the fact that they work with a DAC converter, having a finite resolution. It should be noted that simply increasing the resolution is not an appropriate solution since this will decrease the ability to react on fast input changes and increase the chip area for the integrated circuit.

The present invention addresses the above-mentioned problems associated with conventional systems by using a controller which advantageously utilizes a switched capacitor (SC) arrangement enabling an exponential or analog type response on a step error for improved system response. Further, an offset cancellation phase is introduced to cancel most, if not all, of the DC offset for improved accuracy. Combined with the fact that the present approach is not value discrete (such as in the UDC approach), the overall system error can be maintained at or well below 5 mV (10%) error.

Referring now to FIG. 1 there is illustrated a block diagram of a constant velocity sampled retract system in accordance with exemplary embodiments of the present invention. In a “float” phase the VCM is disconnected from the driver stage so that the currents in the VCM can decay. The BEMF is sampled during the float phase using a differential amplifier arrangement 11 and provided to the PI-controller 12. A further circuit 13 is used to generated the target BEMF (TBEMF) which is also provided to the controller 12. The controller 12 calculates the actual error, integrates it, and outputs the sum of the integrator and a proportional part. The sum is provided to an output driver 14 which provides drive currents to the VCM.

Switched Capacitor PI Controller

Basic SC Integrator

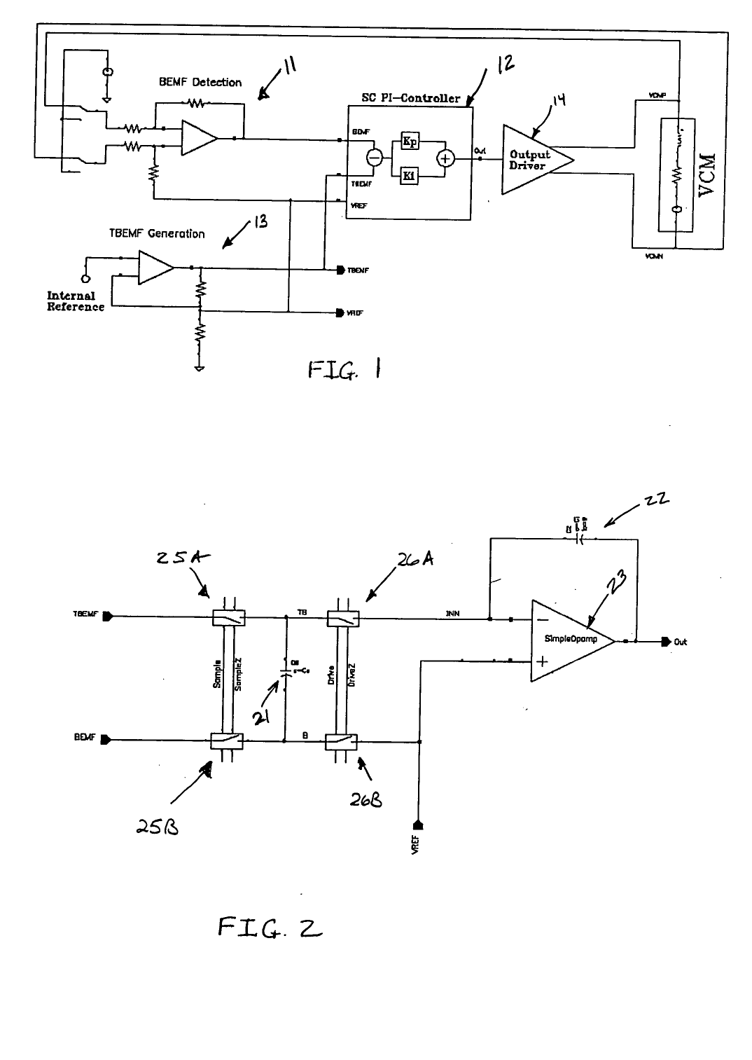

Referring now to FIG. 2 there is shown a diagram of an SC integrator in accordance with exemplary embodiments of the present invention. The difference between BEMF and TBEMF (the actual error) is sensed on capacitor 21 in phase 1 while switches 25A and 25B are closed. At the end of this phase the switches 25A and 25B are opened and the charge on C21 is proportional to the error and the capacitor value. Subsequently, the capacitor 21 is switched between the negative and positive input of the operational amplifier 23 in phase 2 using switches 26A and 26B. During this phase, because the opamp attempts to regulate its input differential voltage to 0, effectively all the charge is transferred from C21 to C22. At the end of phase 2 the switches 26A and 26B are opened and the cycle starts over with phase 1. Doing this continuously integrates the error at the input on capacitor 22.

SC PI Controller

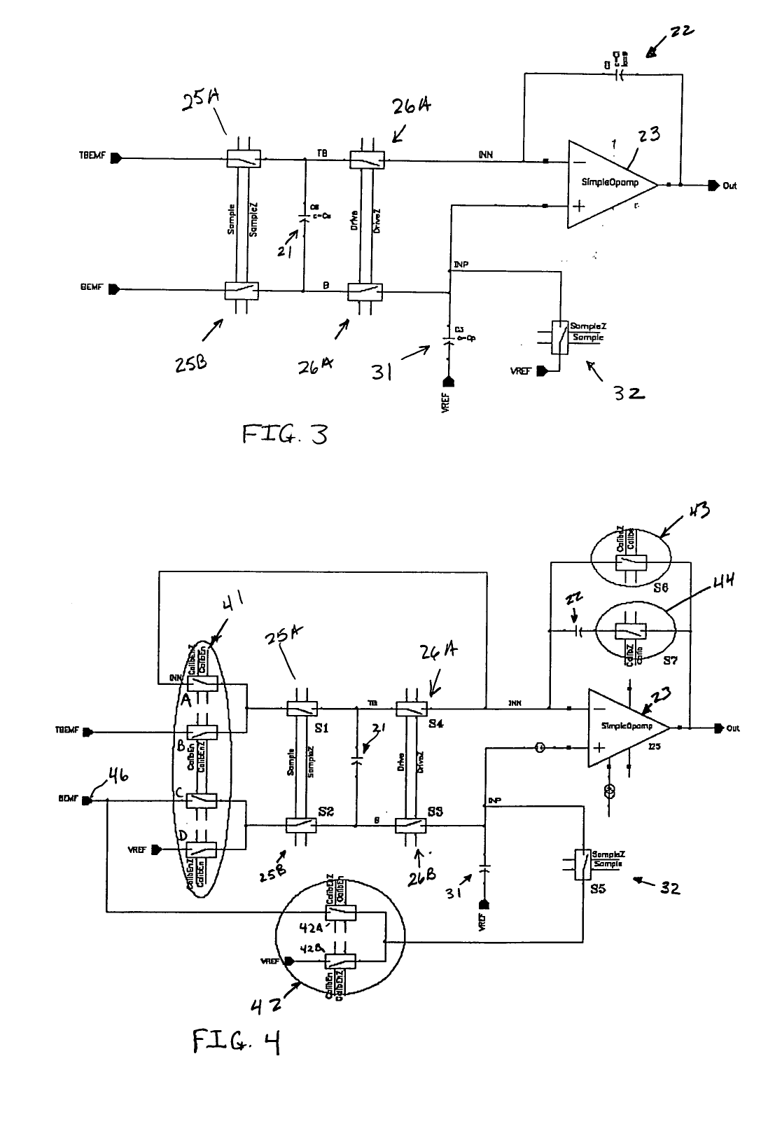

Referring now to FIG. 3 there is shown an SC controller based on the SC integrator shown in FIG. 2 in accordance with exemplary embodiments of the present invention. Two components have been added to the integrator of FIG. 2: a capacitor 31 connected from the positive input of the amplifier to VREF and a parallel reset switch 32. Sampling works basically as before. The input (error) voltage is stored on the sampling capacitor 21 and in addition the reset switch 32 is closed in order to discharge the capacitor 21 and connect the opamp 23 to VREF. In the storage phase, the sampling capacitor 21 is connected to the opamp inputs again and the reset switch 32 is opened. Still the opamp 23 tries to regulate the input voltage to zero and integrates the charge on the feedback capacitor 22. But this time the charge also is stored on the third capacitor 31 which provides a common mode signal to the system. This common mode signal is proportional to the input voltage and the ratio of the sampling capacitor 21 to the third capacitor 22 (this is effectively the proportional part Kp as shown in FIG. 1). The output signal finally is that proportional part plus the voltage across the integrating capacitor 22 (this is effectively the integral part K₁ as shown in FIG. 1).

SC PI Controller with Error Cancellation

Referring now to FIG. 4 there is shown an SC controller with error cancellation in accordance with exemplary embodiments of the present invention. System error can come from, for example, the input offset of the BEMF amplifier 11 (FIG. 1) and the TBEMF generation 13 (FIG. 1) and integrator amplifier 23 (FIG. 2). For the error cancellation two additional phases are introduced to the circuit illustrated in FIG. 3 and effectuated by the switches shown as items 41-44. They basically can be seen as another sample and storage phase which senses the system error and stores it with the opposite sign, so that it can be used to cancel the error made in the “real” sampling phase.

The additional phases are performed during the float in which also the system error is measured and stored. Basically the sample and drive phase are executed twice: once in calibration mode and once in BEMF measure mode.

In the calibration phase the switches 42a,43,41A,41D are closed all the time. Switch 44 is open all the time to avoid destroying the charge on capacitor 22. By closing switch 32 the offset of the BEMF amplifier at 46 (where the amplifier inputs are shorted to VREF during this time) is switched to the positive input of the integrator opamp 23. Opamp 23 is switched into buffer using switch 43 and switches 41A, 41D, 25A and 25B are configured to store the difference between the output voltage of opamp 23 and Vref on capacitor 21. At the end of this phase the switches 25A, 25B and 32 are opened. In the drive phase the switches 26A and 26B are closed and the charge on capacitor 21 is transferred to capacitor 31. This one now has stored both the offset of the BEMF amplifier and the offset of opamp 23. At the end of this phase 26A and 26B are opened again.

In the measurement phase the switches 42b,44,41B,41C are closed all the time, switches 32 and 43 remain open. The measurement is done by closing 25A and 25B in the sample phase and storing the error voltage on capacitor 21. In the drive phase the charge on C21 is transferred to capacitor 31 (proportional part) and capacitor 22 (integral part). Because of the opposite polarity of the offset stored in the calibration phase on capacitor 32 and the offset sampled in the measurement phase it cancels out and does not show up on the proportional part or the integral part. An illustration of the phase timing is shown in FIG. 7.

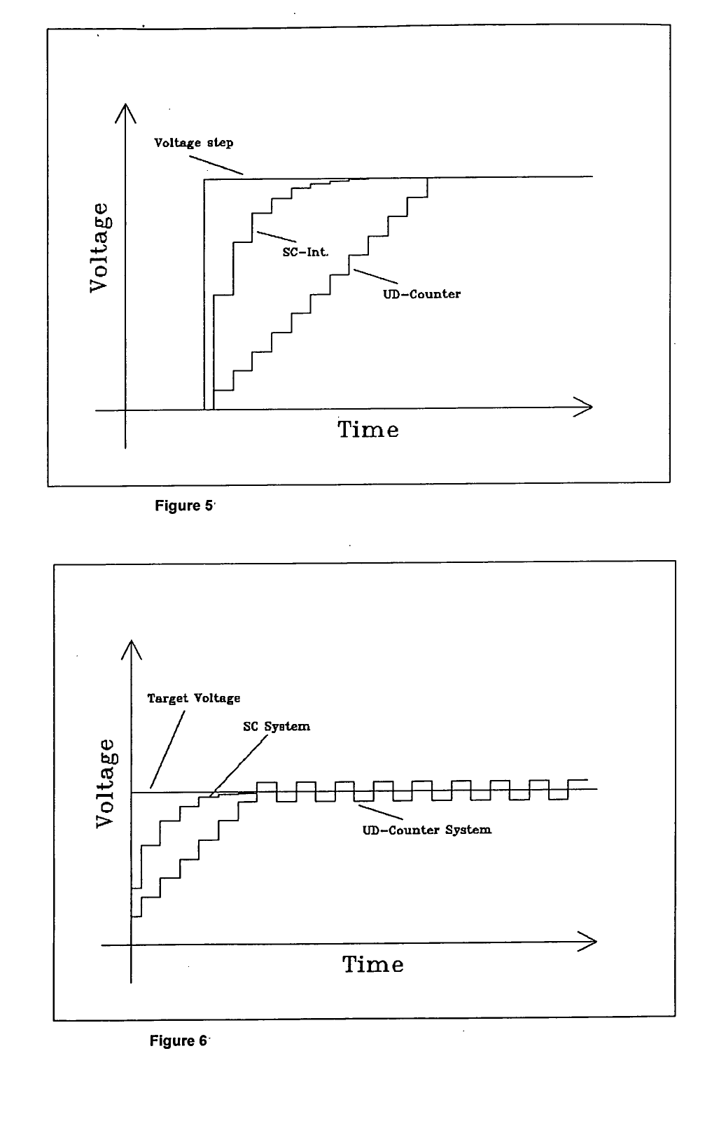

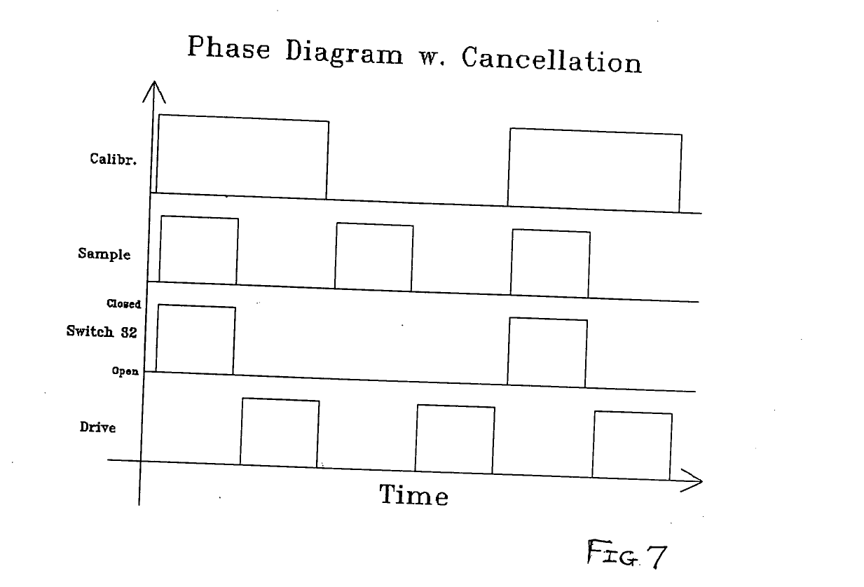

A significant difference between the present SC approach and the prior UDC approach is illustrated in the respective step responses as illustrated in FIG. 5. As shown, the step response of the UDC approach reacts with constant step sizes in time and voltage. The present SC approach also has a constant step in time, but with a step voltage step proportional to the error voltage which makes for a faster response (settling time) for the same time step size. Additionally, referring to FIG. 6, the step response of the UDC approach has a finite voltage resolution (depending on the UDC depth and the DAC) creating a finite ripple and residual error about the target voltage at the output. As shown, the present SC approach offers an infinite resolution in voltage thus regulating to a constant voltage at the target voltage.

Although exemplary embodiments of the invention are described above in detail, this does not limit the scope of the invention, which can be practiced in a variety of embodiments.

1. An apparatus for controlling an actuator having a moveable member and having a coil that influences movement of the member via a drive current to said coil, comprising:
a sensing unit for sensing a voltage corresponding to the voltage across said coil and providing a first signal corresponding to said sensed voltage and indicative of the velocity of said moveable member;
a generation circuit for providing a second signal indicative of a target voltage corresponding to a target velocity for said moveable member; and
a controller receiving said first signal and said second signal and responsive thereto for determining a compensation signal characterized as an analog type response regulated to said target voltage for effectuating said target velocity.

2. The apparatus of claim 1, wherein said compensation signal is further characterized as an analog type response regulated to said target voltage with a resolution free of ripple about said target voltage.

3. The apparatus of claim 1, wherein said compensation signal is characterized by a voltage step which is proportional to a remaining error with an infinite resolution approaching said target voltage over a constant time period.

4. The apparatus of claim 1, wherein said controller includes a first node for receiving said first signal and said second signal and determining a difference therebetween and providing said difference to a proportional part and an integrator part;
said integrator part providing a third signal which is indicative of a mathematical integration of said difference and said proportion part providing a forth signal which is indicative of a multiple of said difference; and
said controller further having a summing node for receiving said third signal and said forth signal and responsive thereto for determining a summed signal which corresponds to said compensation signal.

5. The apparatus of claim 4, wherein said third signal is a voltage signal characterized by a voltage step which is proportional to a remaining error.

6. The apparatus of claim 4 further including a cancellation circuit coupled with said sensing unit and said integrator part for canceling DC offset.

7. The apparatus of claim 4 further including a cancellation circuit coupled with said sensing unit and operable for determining a DC offset and providing said DC offset to said integrator part for said mathematical integration for canceling said DC offset from said compensation signal.

8. The apparatus of claim 4 further including a cancellation circuit coupled with said sensing unit and said integrator part and operable for determining DC offset of said sensing unit and said integrator part and providing said DC offset to said integrator part for said mathematical integration for canceling said DC offset from said compensation signal.

9. The apparatus of claim 8, wherein said DC offset is determined prior to sensing said coil voltage.

10. The apparatus of claim 1 further including an amplifier unit having an input for receiving said compensation signal and responsive thereto for providing a corresponding current for application to said coil.

11. An apparatus for providing a current signal to an actuator having a moveable member and having a coil that influences movement of the member responsive to the current signal, comprising:
a first input for receiving a first signal corresponding to the voltage sensed across said coil which is indicative of the velocity of said moveable member
a second input for receiving a second signal indicative of a target voltage corresponding to a target velocity for said moveable member;
a node for receiving said first signal and said second signal and determining a difference therebetween and providing said difference to a proportional part and an integrator part;
said integrator part providing a third signal which is indicative of a mathematical integration of said difference and said proportion part providing a forth signal which is indicative of a multiple of said difference; and
a summing node for receiving said third signal and said forth signal and responsive thereto for determining a compensation signal from a sum of said third and forth signal, said compensation signal characterized as an analog type response regulated to said target voltage for effectuating said target velocity.

12. The apparatus of claim 11, wherein said compensation signal is further characterized as an analog type response regulated to said target voltage with a resolution free of ripple about said target voltage.

13. The apparatus of claim 11, wherein said compensation signal is characterized by a voltage step which is proportional to a remaining error with an infinite resolution approaching said target voltage over a constant time period.

14. The apparatus of claim 11 further including a cancellation circuit coupled with said sensing unit and said integrator part for canceling DC offset.

15. The apparatus of claim 11 further including a cancellation circuit coupled with said sensing unit and operable for determining a DC offset and providing said DC offset to said integrator part for said mathematical integration for canceling said DC offset from said compensation signal.

16. The apparatus of claim 11 further including a cancellation circuit coupled with said sensing unit and said integrator part and operable for determining DC offset of said sensing unit and said integrator part and providing said DC offset to said integrator part for said mathematical integration for canceling said DC offset from said compensation signal.
